(19) United States
(12) Patent Application Publication
(10) Pub. No.: US 2013/0306583 A1
(43) Pub. Date: Nov. 21, 2013

(54) Rack System

(71) Applicant: Johnnie Caldwell, Fountain Hills, AZ (US)

(72) Inventor: Johnnie Caldwell, Fountain Hills, AZ (US)

(21) Appl. No.: 13/506,795

(22) Filed: May 17, 2012

(51) Int. Cl. A47B 96/00; B23Q 17/00

(52) U.S. Cl. 211/181.1; 29/407.09

(57) ABSTRACT

A divider for shelving units comprising a plurality of horizontal wires a plurality of vertically wires in contact with the plurality of horizontal wires, each contact area attached to form a rigid structure; a base edge having at least one extra horizontal base wire located directly opposite the lowest horizontal wire so as to create a series of base spaces along the base of the divider; at least one attachable divider clip, the divider clip comprises a clip body with a curved end, located in the clip body is a bolt receiving slot; a clip securing mechanism, and at least one hanger structure, which comprises a hook guide that received a slidable hook, the hook guide is attached to the divider near a top edge to a vertical wire in a generally parallel configuration.

### FIELD OF THE INVENTION

The present invention encompasses a system for creating vertical barriers in a wide variety of modular shelving systems, especially those constructed of wire.

### BACKGROUND

Bare modular shelving systems formed of wire, plastic, or rubber-coated wire are well-known systems used frequently in industrial, commercial and residential spaces for storage. This shelving is formed primarily out of bent metal or plastic wire and generally remains uncovered. U.S. Pat. Nos. 7,334,692, 6,116,436, and 5,221,014 contain examples of such systems. Modular wire shelving is strong, light, and relatively inexpensive and thus is widely used in areas where attractiveness is not a first concern (such as a stock rooms and garages). Most commonly, these systems contain no barriers along the horizontal portion of each shelf, meaning that each shelf forms one continuous horizontal plane without divisions. Many users of these systems desire a way to apportion space on a shelf for more convenient, organized storage. Some devices have been created to solve this consumer need however they all suffer from distinct flaws.

The current state of the art for horizontal dividers designed for modular wire shelf systems consists overwhelmingly of dividers formed of metal or plastic that connects at the base to one shelf, and is of a non-adjustable size.

The vast majority of current dividers use wire tension to connect to the shelves. U.S. Pat. Nos. 6,460,710 and 7,950,537 are examples of tension-based dividers. Each of these devices features multiple drawbacks. First, the dividers are only connected to the base of one shelf creating issues with support and structure. Second, the dividers do not continue the full height of the shelf meaning that they will not work properly to contain taller objects. Third, the divider is static in size and cannot adapt to fit shelving of different heights securely. Fourth, the method of securing such a divider is through the use wire tension, eventually requiring the device to be replaced.

Dividers that do not rely on tension still have significant issues. U.S. Pat. No. 4,560,073 displays similar issues with height and adjustability, although it does not rely on tension. U.S. Pat. Nos. 4,190,167, 4,729,485, and 3,608,741 are similar dividers. While they do not rely on tension for support, the height of the divider is static and cannot be adjusted for taller or shorter shelving systems.

Patent application Ser. No. 09/934,560 describes a device with very similar deficiencies. While this device can attach to the base as well as a rear panel for additional support, it still is not adjustable for height.

Currently adjustable dividers are poorly suited to create vertical barriers. A telescoping divider, as described by U.S. Pat. No. 6,685,037, suffers from several design flaws. If aligned horizontally the rack is not adjustable for height. If aligned vertically the rack is structurally unsound at the joint between the front frame and the rear frame.

It is clear that an improved divider for modular wire shelf systems is needed that is both structurally sound and adjustable for a wide variety of heights.

### SUMMARY OF INVENTION

It is an object of the present invention to provide a divider for shelving units comprising a plurality of horizontal wires a plurality of vertically wires in contact with the plurality of horizontal wires, each contact area attached to form a rigid structure; a base edge having at least one extra horizontal base wire located directly opposite the lowest horizontal wire so as to create a series of base spaces along the base of the divider; at least one attachable divider clip, the divider clip comprises a clip body with a curved end, located in the clip body is a bolt receiving slot; and a at least one clip securing mechanism.

It is another object of the present invention to provide a divider for shelving units comprising a plurality of horizontal wires a plurality of vertically wires in contact with the plurality of horizontal wires, each contact area attached to form a rigid structure; a base edge having at least one extra horizontal base wire located directly opposite the lowest horizontal wire so as to create a series of base spaces along the base of the divider; at least one attachable divider clip, the divider clip comprises a clip body with a curved end, located in the clip body is a bolt receiving slot; a clip securing mechanism, and at least one hanger structure, which comprises a hook guide that received a slidable hook, the hook guide is attached to the divider near a top edge to a vertical wire in a generally parallel configuration.

It is still yet another object of the present invention to provide a method for providing a divider in a shelving unit comprising the steps of: providing at least one divider for the shelving unit comprising: a plurality of horizontal wires, a plurality of vertically wires in contact with the plurality of horizontal wires, each contact area attached to form a rigid structure; and a base edge having at least one extra horizontal base wire located directly opposite the lowest horizontal wire so as to create a series of base spaces along the base of the divider; providing at least one attachable divider clip for each of the at least one divider, the divider clip comprises a clip body with a curved end, located in the clip body is a bolt receiving slot; providing a clip securing mechanism for each of the at least one attachable divider clip; aligning each divider front to back on a bottom shelf of the shelving unit, placing each clip under a base edge of the divider with the curved end of the clip receiving a portion of a side to side wire of the bottom shelf; inserting a bolt through the bolt receiving slot and into the base space between the two base wires; and threading nut structure, such as a wing nut, onto the bolt thereby securing the divider to the bottom shelf.

It is a further object of the present invention to provide a method for providing a divider in a shelving unit comprising the steps of: providing at least one divider for the shelving unit comprising: a plurality of horizontal wires; a plurality of vertically wires in contact with the plurality of horizontal wires, each contact area attached to form a rigid structure; a base edge having at least one extra horizontal base wire located directly opposite the lowest horizontal wire so as to create a series of base spaces along the base of the divider; and at least one hanger structure, which comprises a hook guide that received a slidable hook, the hook guide is attached to the divider near a top edge to a vertical wire in a generally parallel configuration; providing at least one attachable divider clip for each of the at least one divider, the divider clip comprises a clip body with a curved end, located in the clip body is a bolt receiving slot; providing a clip securing mechanism for each of the at least one attachable divider clip; aligning each divider front to back on a bottom shelf of the shelving unit, placing each clip under a base edge of the divider with the curved end of the clip receiving a portion of a side to side wire of the bottom shelf; inserting a bolt through the bolt receiving slot and into the base space between the two base wires; threading nut structure, such as a wing nut, onto the bolt thereby securing the divider to the bottom shelf; moving the slidable hook from a first, lowered position to a second, extended position, and placing or lowering a crook of the slidable hook over either a side to side wire or a front to back wire of a top shelf, thereby providing additional lateral stability.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1 is a perspective view of the present invention.

FIG. 2 is a side view of the same.

FIG. 3 is a perspective view of the clip according to the present invention.

FIG. 4 is a side view of the same.

FIG. 5 shows a top and bottom shelf (supporting structure omitted) with three dividers installed.

FIG. 6 shows a shelf system with several different embodiments of dividers installed.

FIG. 7 shows a bottom, middle and top shelf, the bottom and middle shelf featuring installed dividers.

FIG. 8 shows a bottom and top shelf with a divider installed.

FIG. 9 shows a bottom shelf with an exploded view of a divider.

FIG. 10 shows a bottom shelf, a top shelf and an alternate embodiment of the divider which is only fashioned at its base to the bottom shelf.

FIG. 11 shows a bottom shelf with an exploded view of an alternate embodiment of a divider which only attaches to the bottom shelf.

### DETAILED DESCRIPTION OF PREFERRED EMBODIMENTS

The present invention is a device that creates removable vertical barriers in a variety of modular shelving, especially those constructed with wire. The present invention can be produced in a number of embodiments, as is discussed below.

In a preferred embodiment, shelves 10 are constructed out of a grid of overlapping wires to form stable surfaces. Wires 20 lay in a front to back direction and wires 22 lay in a side to side direction. Generally, the wires 20 are welded to the wires 22 in order to form a stable shelf structure 12 or 14.

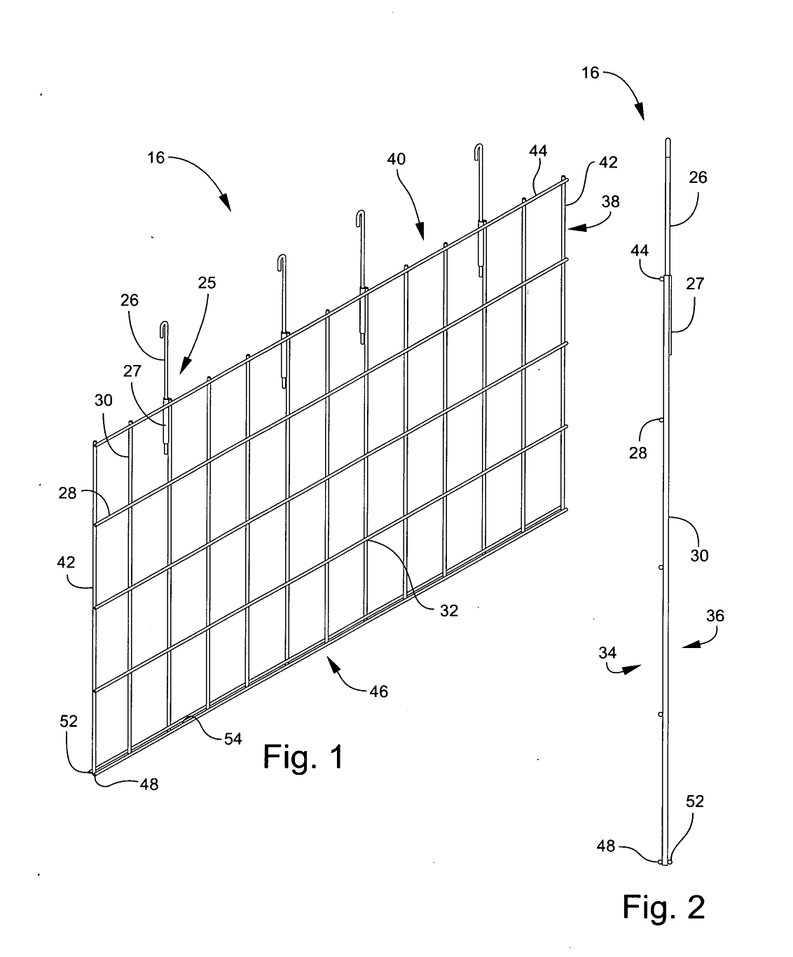

In a preferred embodiment, illustrated in FIGS. 1 and 2, the dividers 16 are formed by a grid of wires, a plurality of which are each laid horizontally 28 and vertically 30. Each contact area 32 in the grid is joined or welded to form a rigid grid structure. In this embodiment the divider 16 is manufactured in such a way that horizontal wires 28 form a right facing surface 34 while vertical wires 30 form a left facing surface 36. The grid is cut in such a way that side edges 38 and top edge 40 of the divider 16 are formed by the edge-most vertical wire 42 and top-most horizontal wire 44.

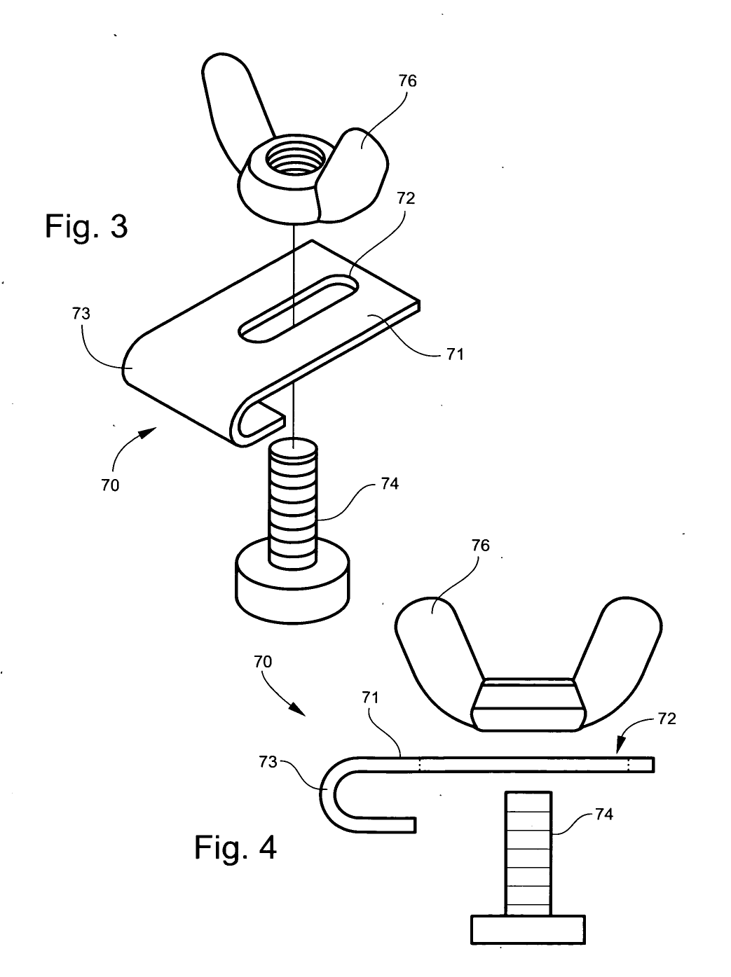

The divider 16 of the present invention further comprises an attachable divider clip 70, illustrated in FIGS. 3 and 4. The divider clip 70 comprises a generally rectangular shaped flat clip body 71 with a curved end 73. The curvature of the end 73 is generally parallel to the short side of the rectangular shape of the body 71 of the clip 70 such that a cross section of the clip 70 is hook shaped. Located in the clip body 71 is a bolt receiving slot 72.

In one embodiment, the dividers 16 further comprise at least one hanger structure 25, preferably two, more preferably four, which comprises a hook guide 27 that received a slidable hook 26. In a preferred embodiment, the hook guide 27 is attached to the divider 16 near the top edge 40 by welding the hook guide 27 to a vertical wire 30 in a generally parallel configuration. In the preferred embodiment, the slidable hook 26 is relative permanently, but slidably, received by the hook guide 27 such that extra-ordinary effort must be used to remove it from the hook guide 27.

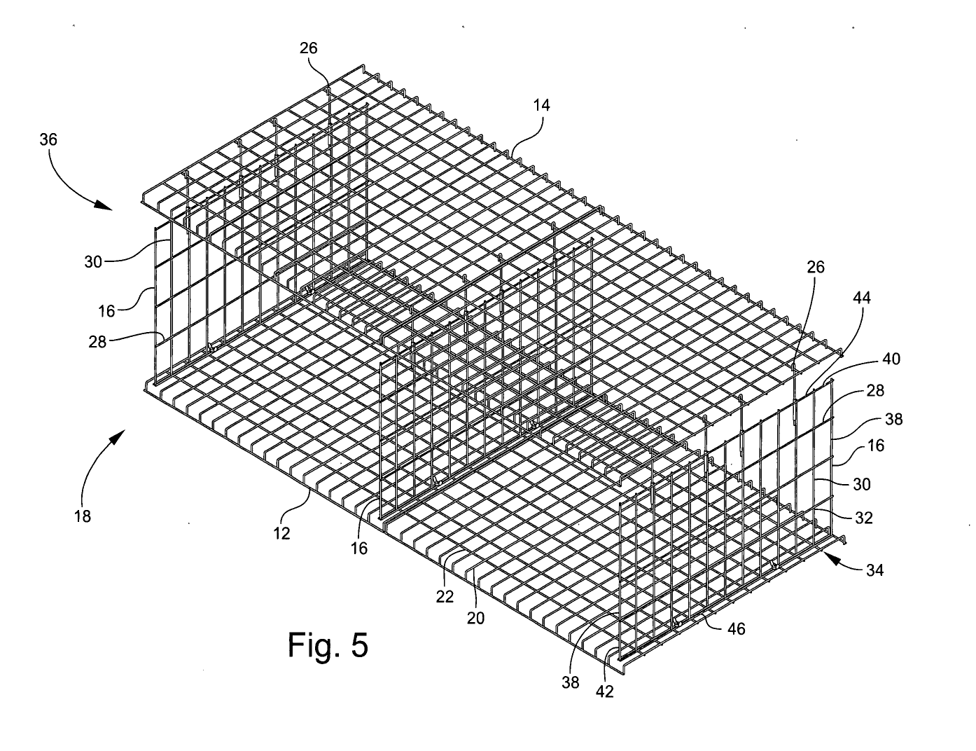

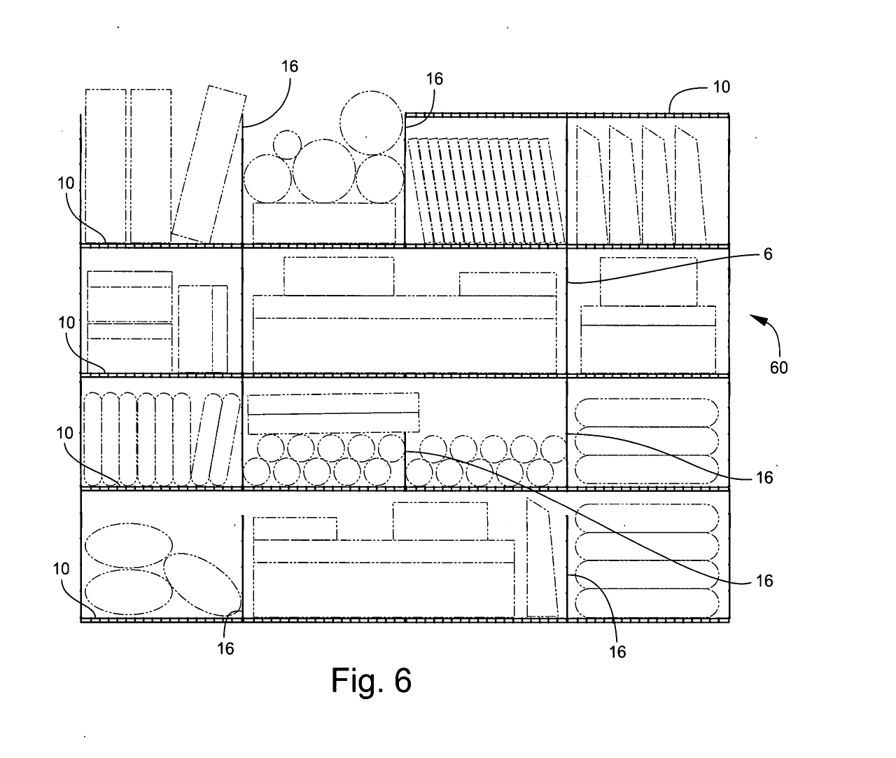

FIG. 5 demonstrates an embodiment of a divider 16, according to the present invention, secured to shelves located above and below the divider 16. Depicted are a bottom shelf 12 and a top shelf 14 with three vertical dividers 16 mounted between the bottom and top shelves 12 and 14. The shelves 12 and 14 are oriented so that a front section 18 is open and not obscured. Shelf supporting structures are omitted.

In use, the dividers 16 are attached to the bottom shelf 12 by using the attachable clip 70 in combination with the bolt 74 and nut 76 mechanism.

FIG. 6 demonstrates a shelf system 60 containing a variety of different embodiments of the dividers 16 used on shelves 10. As shown, the present invention can be embodied in several fashions. Some embodiments of the dividers 16 have supports at the bottom and top of the divider and some dividers only have bottom supports.

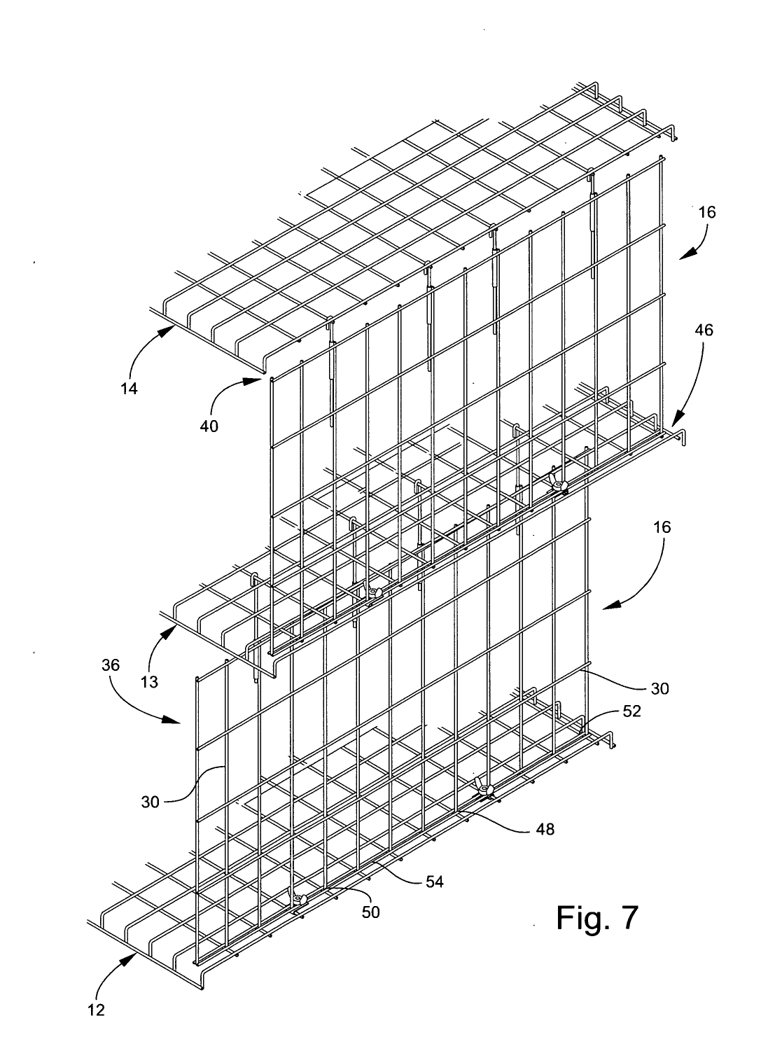

FIG. 7 shows a bottom shelf 12, a middle shelf 13, and a top shelf 14. Two dividers 16 are shown forming vertical barriers between the bottom shelf 14 and middle shelf 13. This embodiment of the divider 16 is joined at the top 66 and base 46 of the divider 16. At the base 46 the grid is set up such that the vertical wires 30 extend slightly past the lowest horizontal wire 48 and extrude to form tips 50. Also at the base 46 of the divider 16 at least one extra horizontal base wire 52 is placed on the left facing surface 36 over the vertical wires 30 directly opposite the lowest horizontal wire 48 so as to create a series of base spaces 54 along the base of the divider 16. In this embodiment of the divider 16 the horizontal wires 28 and the vertical wires 30 are spaced apart to conserve cost and weight. Size of spacing between horizontal wires 28 and vertical wires 30 can vary or be eliminated.

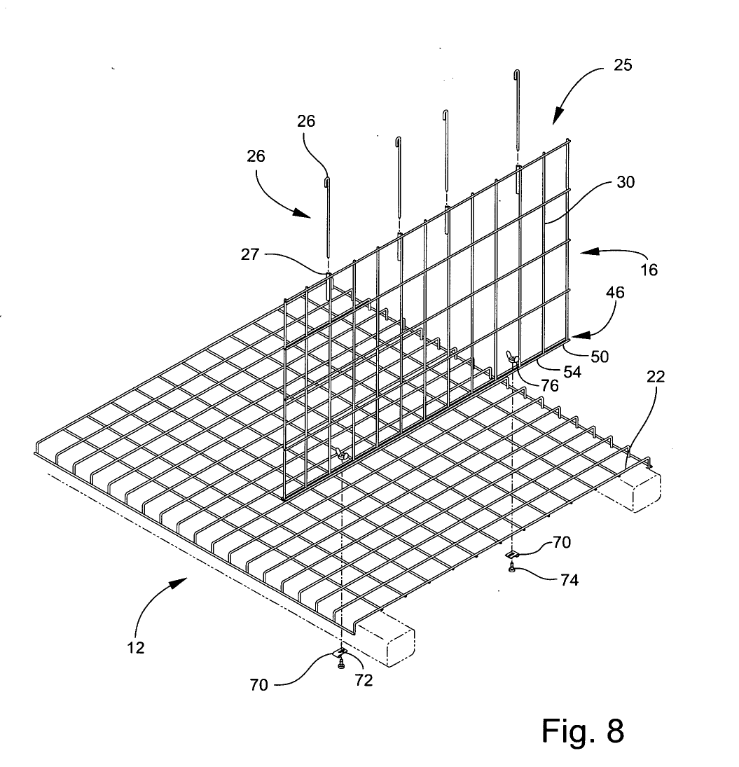

FIG. 8 illustrates, in more detail, the way the divider 16 is secured to a bottom shelf 12. In use, the dividers 16 are attached to the bottom shelf 12 by using the attachable clip 70 in combination with a bolt and nut mechanism. The dividers 16 are aligned on a bottom shelf 12, front to back. The clip 70 is placed under the foot section 24 of the divider 16 with the curved end of the clip 70 receiving a portion of a side to side wire 22 of the bottom shelf. A bolt is inserted through the bolt receiving slot and between the two base wires 52. A nut structure, such as a wing nut, is threaded onto the bolt and tightened thereby securing the divider to the bottom shelf 12. In a preferred embodiment, at least one, preferably at least two clips 70 are used to secure the divider 16 to the bottom shelf 12.

Generally, for shorter dividers 16, such as the ones that do not include hanger structures, clips 70 are all that is required to keep the dividers 16 attached to the bottom shelf 12 and in a generally upright position.

Taller dividers 16, on the other hand, may require the additional support supplied by the at least one hanger structures. With these dividers, the bottom of the dividers 16 are attached as described above using at least one clip 70. Additionally, the top of the dividers 16 may be secured to a top shelf 14 by moving the slidable hook 26 from a first, lowered position to a second, extended position. The crook of the slidable hook may then be placed over either a side to side wire 22 or a front to back wire 20 of the top shelf 14, thereby providing additional lateral stability. This is repeated with additional hanger structures if they are provided.

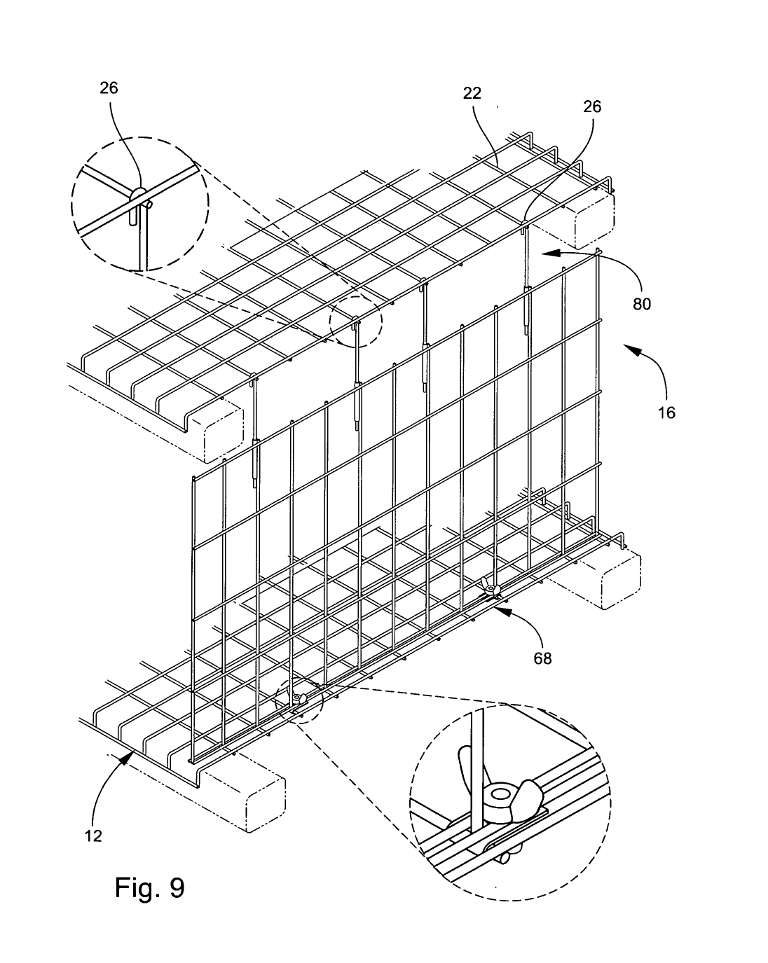

FIG. 9 the way the divider 16 is secured to a bottom shelf 12 and top shelf 14. To join the base 46 of the divider 16 to a bottom shelf 12 at least one slotted clip 70 is inserted over one of the side to side 22 wires of the bottom shelf 12. Tip 50 is inserted into the bolt receiving aperture 72 to secure the divider 16. A bolt 74 is placed through the aperture 72 in the clip 70 and one of the base spaces 54 at the base 46 of the divider 16. To secure the bolt 74 a nut 76 such as a butterfly nut is inserted and tightened forming a stable perpendicular angle between the bottom shelf 12 and the divider 16. In this embodiment the divider 16 is attached for extra security to the top shelf 14 (omitted) with at least one hanger structure 25.

The hanger structures 25 are formed of two pieces, the hook guide 27 and the slidable hook 26. The hook guide 27 is attached to the divider's 16 vertical wires 30. The slidable hook is formed by a length of wire which has been doubled over at one end to form a crook. The body of the slidable hook 26 is inserted through the hook guide 27 and the portion of the body that protrudes from the lower end of the hook guide 27 is hammered flat or otherwise secured to prevent the slidable hook 26 from being removed from the hook guide 27, while still allowing the slidable hook 26 to extend and retract.

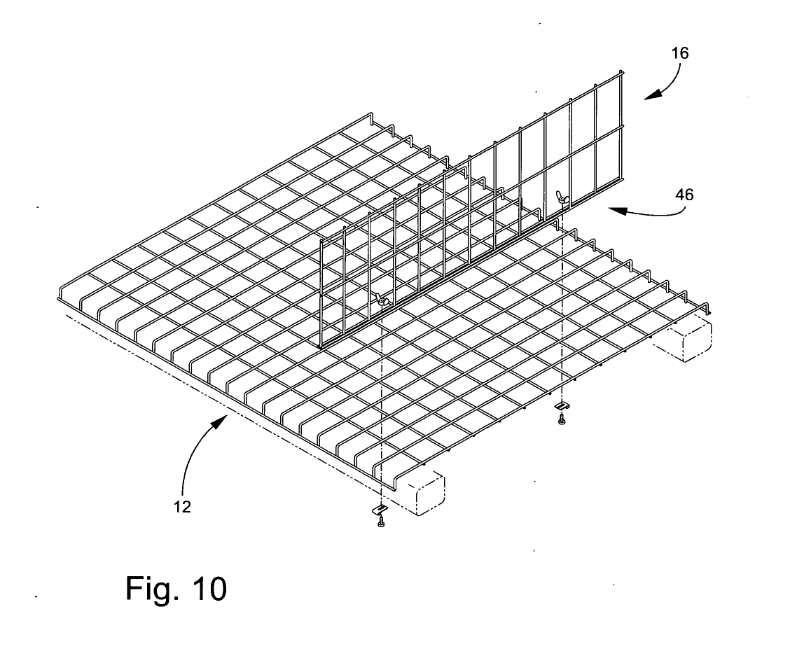

FIG. 10 shows an alternate embodiment of the divider 16 which only attaches only to the bottom shelf 12 and not to the top shelf 14. This embodiment is ideal for shorter shelf heights, or in situations where tall barriers are not wanted or needed. This divider 1.6 attaches to the bottom shelf 12 using the same clip 70 in the same fashion as the other embodiments.

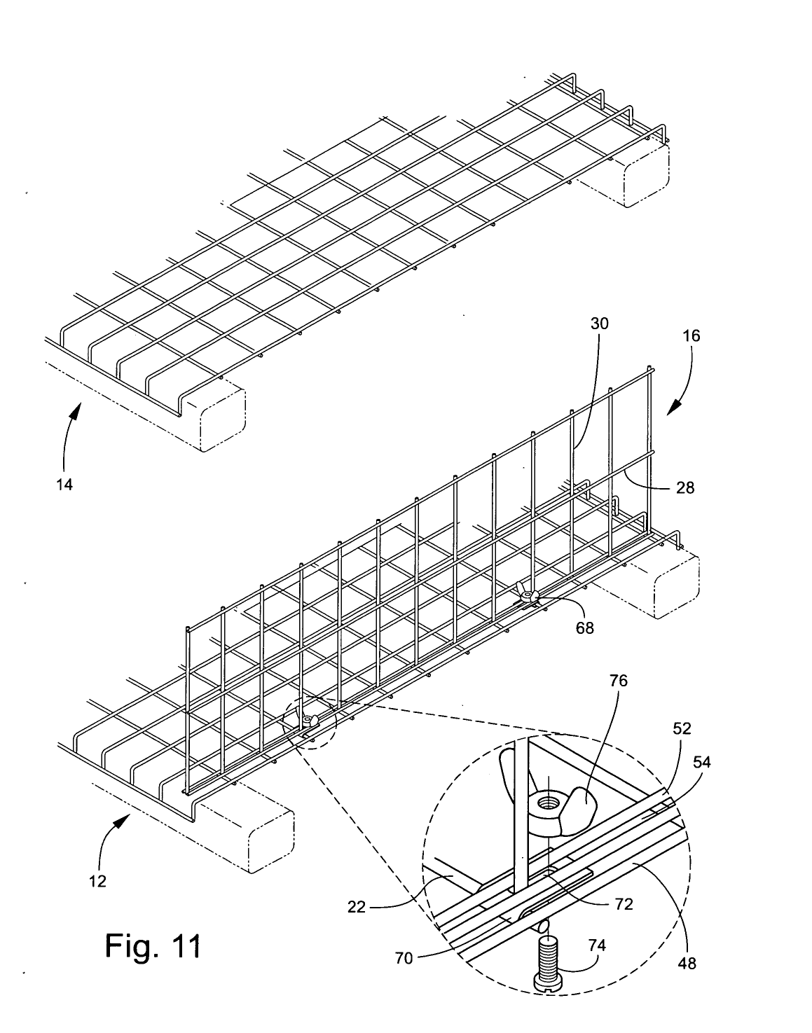

FIG. 11 shows the divider 16 that is only attached at the base 46 to the bottom shelf 12.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A divider for shelving units comprising:
a) a plurality of horizontal wires;
b) a plurality of vertically wires in contact with the plurality of horizontal wires, each contact area attached to form a rigid structure;
c) a base edge having at least one extra horizontal base wire located directly opposite the lowest horizontal wire so as to create a series of base spaces along the base of the divider;
d) at least one attachable divider clip, the divider clip comprises a clip body with a curved end, located in the clip body is a bolt receiving slot;
e) at least one clip securing mechanism.

2. The divider according to claim 1 further comprising at least one hanger structure, which comprises a hook guide that received a slidable hook, the hook guide is attached to the divider near a top edge to a vertical wire in a generally parallel configuration.

3. The divider according to claim 2 wherein the slidable hook is relative permanently, but slidably, received by the hook guide such that extra-ordinary effort must be used to remove it from the hook guide.

4. The divider according to claim 2 wherein there are four hanger structures attached to each divider.

5. The divider according to claim 3 wherein there are four hanger structures attached to each divider.

6. A method for providing a divider in a shelving unit comprising the steps of:
a) providing at least one divider for the shelving unit comprising:
i) a plurality of horizontal wires;
ii) a plurality of vertically wires in contact with the plurality of horizontal wires, each contact area attached to form a rigid structure; and
iii) a base edge having at least one extra horizontal base wire located directly opposite the lowest horizontal wire so as to create a series of base spaces along the base of the divider;
b) providing at least one attachable divider clip for each of the at least one divider, the divider clip comprises a clip body with a curved end, located in the clip body is a bolt receiving slot;
c) providing a clip securing mechanism for each of the at least one attachable divider clip;
d) aligning each divider front to back on a bottom shelf of the shelving unit,
e) placing each clip under a base edge of the divider with the curved end of the clip receiving a portion of a side to side wire of the bottom shelf;
f) inserting a bolt through the bolt receiving slot and into the base space between the two base wires; and
g) threading nut structure, such as a wing nut, onto the bolt thereby securing the divider to the bottom shelf.

7. A method for providing a divider in a shelving unit comprising the steps of:
a) providing at least one divider for the shelving unit comprising:
i) a plurality of horizontal wires;
ii) a plurality of vertically wires in contact with the plurality of horizontal wires, each contact area attached to form a rigid structure;
iii) a base edge having at least one extra horizontal base wire located directly opposite the lowest horizontal wire so as to create a series of base spaces along the base of the divider; and
iv) at least one hanger structure, which comprises a hook guide that received a slidable hook, the hook guide is attached to the divider near a top edge to a vertical wire in a generally parallel configuration;
b) providing at least one attachable divider clip for each of the at least one divider, the divider clip comprises a clip body with a curved end, located in the clip body is a bolt receiving slot;
c) providing a clip securing mechanism for each of the at least one attachable divider clip;
d) aligning each divider front to back on a bottom shelf of the shelving unit,
e) placing each clip under a base edge of the divider with the curved end of the clip receiving a portion of a side to side wire of the bottom shelf;
f) inserting a bolt through the bolt receiving slot and into the base space between the two base wires;
g) threading nut structure, such as a wing nut, onto the bolt thereby securing the divider to the bottom shelf;
h) moving the slidable hook from a first, lowered position to a second, extended position, and
i) placing or lowering a crook of the slidable hook over either a side to side wire or a front to back wire of a top shelf, thereby providing additional lateral stability.
